(19) United States
(12) Patent Application Publication
(10) Pub. No.: US 2026/0220974 A1
(43) Pub. Date: Jul. 30, 2026

(54) IMAGE PROCESSING METHOD AND APPARATUS, STORAGE MEDIUM, ELECTRONIC DEVICE, AND PROGRAM PRODUCT

(71) Applicant: Tencent Technology (Shenzhen) Company Limited, Shenzhen (CN)

(72) Inventors: Shen CHEN, Shenzhen (CN); Haixin DING, Shenzhen (CN); Taiping YAO, Shenzhen (CN); Shouhong DING, ShenzheN (CN); Rongrong JI, Shenzhen (CN)

(21) Appl. No.: 19/636,723

(22) Filed: Apr. 1, 2026

Related U.S. Application Data
(63) Continuation of application No. PCT/CN2024/114209, filed on Aug. 23, 2024.

(30) Foreign Application Priority Data
Nov. 20, 2023 (CN) 202311553842.5

(51) Int. Cl. G06V 40/40; G06V 10/74; G06V 40/16

(52) U.S. Cl. CPC G06V 40/45; G06V 10/761; G06V 40/168

(57) ABSTRACT

Embodiments of this application provide an image processing method using an authenticity recognition model performed by an electronic device. The method includes: obtaining a description information set including a plurality of pieces of real description information and a plurality of pieces of forged description information; and separately inputting the plurality of pieces of real description information and the plurality of pieces of forged description information into the authenticity recognition model, to obtain a real text feature and a forged text feature, either of the real description information and the forged description information being configured for indicating whether an object presented in an image is real or forged; the object field indicating a category of the object; and the template field indicating a type of a scene presented by the image; and the object field being embedded in the state field, and the state field being embedded in the template field.

### CROSS-REFERENCE TO RELATED APPLICATIONS

This application is a continuation application of PCT Patent Application No. PCT/CN2024/114209, entitled “IMAGE PROCESSING METHOD AND APPARATUS, STORAGE MEDIUM, ELECTRONIC DEVICE, AND PROGRAM PRODUCT” filed on Aug. 23, 2024, which claims priority to Chinese Patent Application No. 202311553842.5, entitled “IMAGE AUTHENTICITY DETECTION METHOD AND APPARATUS, STORAGE MEDIUM, AND ELECTRONIC DEVICE”, and filed with the China National Intellectual Property Administration on Nov. 20, 2023, all of which are incorporated by reference in their entirety.

### FIELD OF THE TECHNOLOGY

This application relates to the field of artificial intelligence technologies, and in particular, to an image processing method and apparatus, an electronic device, a computer-readable storage medium, and a computer program product.

### BACKGROUND OF THE DISCLOSURE

The rapid development of deepfake technologies also causes a huge security risk while bringing entertainment and convenience.

In an existing detection method, a digital label is used as surveillance information, to recognize whether a face in a corresponding sample image is real or forged. Such a manner of classifying an image based on a label causes a weak generalization capability of a trained model. Consequently, detection accuracy is reduced. More importantly, because training of a model consumes a large amount of time costs, a related technology cannot meet a requirement when an application needs to urgently launch a deepfake detection function.

### SUMMARY

Embodiments of this application provide an image processing method and apparatus, an electronic device, a computer-readable storage medium, and a computer program product, to resolve the forgoing problem in a related art. The technical solutions are as follows:

According to an aspect, an embodiment of this application provides an image processing method performed by an electronic device, the method including:
inputting a target image into an authenticity recognition model, and recognizing whether the target image is a real image or a forged image using the authenticity recognition model, wherein the authenticity recognition model is generated by:
obtaining a description information set, and the description information set including a plurality of pieces of real description information and a plurality of pieces of forged description information;
separately inputting the plurality of pieces of real description information and the plurality of pieces of forged description information into the authenticity recognition model, to obtain a real text feature and a forged text feature; and
either of the real description information and the forged description information including a state field, an object field, and a template field,
the state field being configured for indicating whether an object presented in an image is real or forged;
the object field being configured for indicating a category of the object;
the template field being configured for indicating a type of a scene presented by the image; and
the object field being embedded in the state field, and the state field being embedded in the template field.

According to another aspect, an embodiment of this application provides an electronic device. The electronic device includes a memory, a processor, and a computer program stored on the memory, and the processor executes the computer program to implement operations of the foregoing image processing method.

According to another aspect, an embodiment of this application provides a non-transitory computer-readable storage medium, having a computer program stored therein, the computer program, when performed by a processor, implementing operations of the foregoing image processing method.

### DESCRIPTION OF THE DRAWINGS

To describe technical solutions in the embodiments of this application more clearly, the following briefly describes accompanying drawings required for describing the embodiments.

FIG. 1 is a schematic diagram of a system architecture for implementing an image processing method according to an embodiment of this application.

FIG. 2 is a schematic flowchart of an image processing method according to an embodiment of this application.

FIG. 3 is a schematic diagram of a structure of an authenticity recognition model according to an embodiment of this application.

FIG. 4 is a schematic flowchart of an image processing method according to an embodiment of this application.

FIG. 5 is a schematic flowchart of an image processing method according to another embodiment of this application.

FIG. 6 is a schematic diagram of an application of a video review scenario according to an embodiment of this application.

FIG. 7 is a schematic diagram of a structure of an image processing apparatus according to an embodiment of this application.

FIG. 8 is a schematic diagram of a structure of an electronic device according to an embodiment of this application.

### DESCRIPTION OF THE EMBODIMENTS

The following describes the embodiments of this application with reference to the accompanying drawings in this application. The following implementations described with reference to the accompanying drawings are exemplary descriptions for explaining technical solutions of the embodiments of this application, and do not limit the technical solutions of the embodiments of this application.

A person skilled in the art may understand that, unless specifically stated, singular forms “a”, “an”, and “the” used herein may also include plural forms. The terms “include” and “contain” used in the embodiments of this application mean that the corresponding features may be implemented as the presented features, information, data, steps, operations, elements, and/or components, but do not exclude implementation as other features, information, data, steps, operations, elements, components, and/or a combination thereof supported in the technical field. When an element is referred to as being “connected” or “coupled” to another element, the element may be directly connected or coupled to the another element, or may mean that a connection relationship is established between the element and the another element by using an intermediate element. In addition, “connected” or “coupled” used herein may include wireless connection or wireless coupling. A term “and/or” used herein indicates at least one of items limited by the term. For example, “A and/or B” may be implemented as “A”, “B”, or “A and B”.

To make objectives, technical solutions, and advantages of this application clearer, the following further clearly describes the implementations of this application with reference to the accompanying drawings.

First, several terms involved in this application are introduced and explained.

A computer vision (CV) technology refers to using a camera and a computer to recognize and measure a target instead of human eyes, and further performing graphic processing, to obtain an image more suitable for the human eyes to observe or an image transmitted to an instrument for detection.

A deepfake technology refers to combining and superimposing a picture or a video onto a source picture or video by using a machine learning model such as a generative adversarial network, performing large sample learning by using a neural network technology, and splicing personal voice, facial expressions, and body actions to synthesize fake content. For example, based on the deepfake, an artificial intelligence (AI) face swapping technology, voice simulation, face synthesis, video generation, and the like are implemented. The emergence of the deepfake makes it possible to tamper with or generate highly realistic and indistinguishable audio and video content, ultimately making it impossible for observers to distinguish authenticity with naked eyes.

In a related technology, according to a method for detecting a deepfake image, a digital label is used, and fine-grained semantic information is ignored. The fine-grained semantic information may help a model to improve a generalization capability. Therefore, an inventive concept of the embodiments of this application is to introduce the fine-grained semantic information to a training process of a model, thereby improving a generalization capability of the model.

A contrastive language-image pre-training (CLIP) model is a pretrained neural network model configured for matching an image and a text, and has a zero-shot classification capability.

However, compared with other classification tasks, in a deepfake detection task, real and fake categories cannot be clearly defined by using texts. Therefore, feature information of the image and text matched by the CLIP model cannot be fully utilized, resulting in a poor zero-shot classification capability of the CLIP model.

In other words, in an existing deepfake detection method, a digital label is used, and surveillance information of the digital label does not include semantic information. Therefore, the model cannot learn true meanings of real and fake. In addition, all objects in deepfake pictures are human faces, there is a forgery trace only in a local region of a human face, and real and fake categories cannot be clearly defined by using texts. Consequently, the CLIP model cannot be directly applied to deepfake detection.

An image processing method and apparatus, an electronic device, a non-transitory computer-readable storage medium, and a computer program product provided in this application are intended to resolve the foregoing technical problems in the existing technology.

The technical solutions of the embodiments of this application and technical effects generated by the technical solutions of this application are described below by using descriptions of several exemplary implementations. The following implementations may be referenced to each other or combined with each other. For same terms, similar feature, similar implementation operations, and the like in different implementations, details are not described.

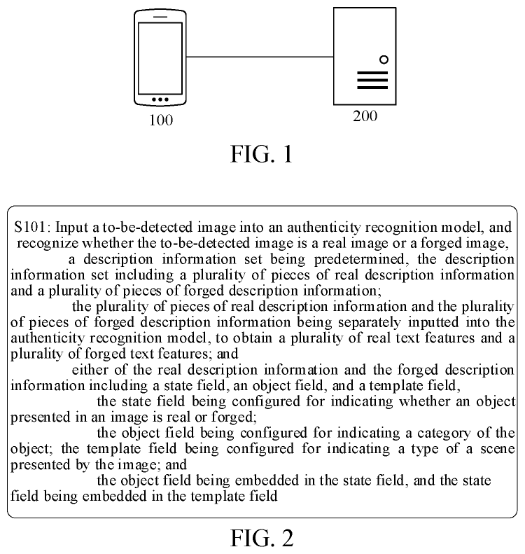

FIG. 1 is a schematic diagram of a system architecture for implementing an image processing method according to an embodiment of this application. The system may include a terminal 100 and a server 200.

The terminal 100 may be an electronic device such as a personal computer (PC), a tablet computer, a mobile phone, or a medical device. A client running a target application program may be installed in the terminal 100. The target application may be an autonomous driving application, or may be another application provided with an image processing function, such as a chat application, an exercise health application, or a life service application. This is not limited in this application.

In addition, a form of the target application is not limited in this application, and includes, but is not limited to, an application (App) and a mini program that are installed in the terminal 100, or may be in a form of a web page. The terminal 100 may alternatively be a vehicle-mounted terminal.

In some embodiments, the vehicle-mounted terminal is configured to capture a facial image of a driver. In some embodiments, the vehicle-mounted terminal may be configured to capture a facial image and detect authenticity of the facial image.

In an example, the vehicle-mounted terminal establishes a connection to the server 200, to detect authenticity of the facial image.

In another example, the vehicle-mounted terminal may detect authenticity of the facial image by itself.

The server 200 may be an independent physical server, may be a server cluster or a distributed system including a plurality of physical servers, or may be a cloud server providing a cloud computing service. The server 200 may be a background server of the foregoing target application, and is configured to provide a background service for the client of the target application.

The terminal 100 may communicate with the server 200 through a network, such as a wired or wireless network.

In the image processing method provided in the embodiments of this application, an execution body of each operation may be a computer device. The computer device is an electronic device having data calculation, processing, and storage capabilities. The solution implementation environment shown in FIG. 1 is used as an example. The terminal 100 may perform the image processing method, for example, a client is installed in the terminal 100, to run the target application, and perform the image processing method, the server 200 may perform the image processing method, or the terminal 100 and the server 200 interact to perform the image processing method. This is not limited in this application. For ease of description, in the following method embodiments, descriptions are provided only by using the computer device as the execution body of each operation of the image processing method.

In some embodiments, the technical solutions provided in this application may be applied to an intelligent traffic scenario. For example, an image capturing device is connected to the vehicle-mounted terminal, and the vehicle-mounted terminal is connected to the server.

In some embodiments, the image capturing device is connected to the vehicle-mounted terminal, and the vehicle-mounted terminal may communicate with the server through a wireless connection. This is not limited in this application.

In some embodiments, the server performs the image processing method, to obtain a trained authenticity recognition model, and deploys the trained authenticity recognition model in the server. The image capturing device captures an image of a driver, and sends the image of the driver to the vehicle-mounted terminal. The vehicle-mounted terminal then uploads the image to the server. The server performs authenticity detection on the image.

In some embodiments, the trained authenticity recognition model may alternatively be deployed in the vehicle-mounted terminal. After receiving the image of the driver sent by the image capturing device, the vehicle-mounted terminal directly performs authenticity detection on the image of the driver, and then determines, according to a recognition result, whether to perform keyless start.

An embodiment of this application provides an image processing method. As shown in FIG. 2, the method includes the following operations.

S101: Input a to-be-detected image into an authenticity recognition model, and recognize whether the to-be-detected image is a real image or a forged image.

In this operation, an authenticity detection result of the to-be-detected image, that is, whether the to-be-detected image is a real image or a forged image, is outputted by using the authenticity recognition model.

In this embodiment of this application, the authenticity recognition model pre-stores a real text feature and a forged text feature.

The real text feature is determined according to each piece of real description information in a predetermined description information set, and represents semantic commonality of all real description information; and the forged text feature is determined according to each piece of forged description information in the description information set, and represents semantic commonality of all forged description information.

In an embodiment, the authenticity recognition model includes a text encoding module, and the real text feature and the forged text feature are determined in the following manners:
obtaining a text feature of each of a plurality of pieces of real description information and a text feature of each of a plurality of pieces of forged description information by using the text encoding module;
obtaining an average value of text features of all the real description information, to obtain the real text feature; and
obtaining an average value of text features of all the forged description information, to obtain the forged text feature.

In this embodiment of this application, the description information set includes a plurality of pieces of description information, and specifically includes the plurality of pieces of real description information and the plurality of pieces of forged description information.

Each piece of description information corresponds to one image and is configured for describing various information of the image. Specifically, each piece of description information has a plurality of fields: a state field, an object field, and a template field, and each field is obtained through alignment (or matching) with the image. Specifically,
(1) The state field is configured for indicating authenticity of an object presented in an image, that is, whether the object is real or forged, which corresponds to whether the description information is real description information or forged description information.

Specifically, information included in the state field may be: real, natural, original, forged, fake, and the like.
(2) The object field is configured for indicating a category of the object presented in the image.

Some forged images are obtained by swapping an animal face with a face. For example, pretraining data of a CLIP model includes a forged image of this type. In this case, the face is no longer a face but is replaced with an animal face. Therefore, in an embodiment, the category indicated by the object field includes a non-face. In this way, pretraining knowledge of the forged image may be used by using a text description of the non-human face.

In another embodiment, to better distinguish a real picture from a forged picture, a model is not to focus on only a matching relationship (or an alignment relationship) between a face image and a text. Therefore, a non-human text description may be further added to description information. In other words, the category indicated by the object field includes a non-human, for example, “cat”, “dog”, and “horse”.
(3) The template field is configured for indicating a type of a scene presented by the image.

A target description manner may be preset to indicate the type of the scene, and includes a keyword, a word order, and the like. For an example, refer to the following Table 1.

The type of the scene may be that the scene is empty, the scene is a house, the scene is office, or the like.

The description information in this embodiment of this application not only needs to describe whether an object presented in an image is real or forged, but also needs to describe content in the image from two dimensions of an object and a template, to enhance interpretability of the authenticity recognition model for a real picture and a forged picture.

In some embodiments, to enable the model to understand content described by each field in one piece of description information more easily, an example in which the description information includes a state field, an object field, and a template field is used. A nesting relationship between the three fields is defined: The object field is embedded in the state field, and the state field is embedded in the template field. If the object field is represented as [c], the state field is represented as [t], and the template field is represented as [t], the description information may be represented as [t[s[c]]].

TABLE 1
Field table

| | |
|---|---|
| Object field | ‘face image’, |
| | ‘dog image’, |
| | ‘cat image’, |
| | ‘horse image’, |
| State field | ‘real { }’, |
| | ‘natural { }’, |
| | ‘original { }’, |
| | ‘vivid { }’, |
| | ‘ lifelike { }’, |
| | ‘{ } without manipulated’, |
| | ‘{ } with eyes, mouth and nose’, |
| | ‘fake { }’, |
| | ‘deepfake { }’, |
| | ‘deep fake { }’, |
| | ‘faceswap { }’, |
| | ‘forged { }’, |
| | ‘manipulated { }’, |
| | ‘altered { }’, |
| | ‘enhanced { }’, |
| | ‘{ } with forgery’, |
| | ‘{ } with alteration’, |
| Template field | ‘A photo of a { }.’, |
| | ‘A dark photo of a { }.’, |
| | ‘A grey photo of a { }.’, |
| | ‘A compressed photo of a { }.’, |
| | ‘A photo of a { } with gaussian blur.’, |
| | ‘A photo of a { } in an indoor environment.’, |
| | ‘A photo of a { } in the room.’, |
| | ‘A photo of a { } in a room with a cityscape in the |
| | background.’, |
| | ‘A photo of a { } in the office.’, |
| | ‘A photo of a { } from an interview.’, |
| | ‘A photo of a { } in the balcony.’, |

Referring to Table 1, Table 1 exemplarily shows a field table of three fields according to an embodiment of this application. In Table 1, a plurality of examples are shown for each field, and in the table, each state field and each template field each have a symbol { }, and the symbol indicates a nested position. One object field may be embedded into { } of one template field. A state field ‘real { }’ and an object field ‘face’ are used as an example. ‘face’ is embedded into ‘real { }’, that is, the state field ‘real {‘face’}’ in which the object field is embedded is obtained. Similarly, ‘real {‘face’} is embedded into a template field, for example, ‘A dark photo of a { }’, that is, a description text ‘A dark photo of a {‘real {‘face’}}’ is obtained.

In a current deepfake method, some forgery operations are usually performed on a facial feature region of a face, resulting in forgery artifacts in in a facial feature part of the face, and image features of the facial feature region may be significantly different from image features of the entire face. A facial feature region of a real face is more real and clear.

Therefore, because regions of eyes, a nose, and a mouth are usually forged in forged faces, and features of eyes, a nose, and a mouth in a real face more match features of corresponding texts, in this embodiment of this application, in comparison with the forged description information, a facial feature field is additionally added to the real description information. The facial feature field is configured for describing facial feature information in the image, for example, may be a text description of “with eyes, mouth and nose”, to improve a classification capability of the model for a real face.

In this embodiment of this application, the description information set is constructed, different description information is configured for describing content of objects in different images, so as to cover image content of all to-be-detected images in terms of text descriptions.

In this embodiment of this application, a real object refers to an object on which AI processing is not performed or that is not generated through AI, and a forged object refers to an object on which AI processing is performed or that is generated through AI.

In some embodiments, a plurality of state fields, a plurality of object fields, and a plurality of template fields may be pre-selected and collected, and then a plurality of pieces of description information are generated in a preset combination manner. Quantities of fields in all the description information are the same, for example, each are 3. Three fields shown in Table 1 are used as an example. Because there are 17 state fields, 11 template fields, and four object fields, 17*11*4=748 pieces of description information may be generated through combination.

In this embodiment of this application, there are two types of authenticity detection results. A first result indicates that the object presented in the image is real, and a second result indicates that the object presented in the image is forged.

According to the image processing method in this embodiment of this application, the to-be-detected image is inputted into the authenticity recognition model, and it is recognized whether the to-be-detected image is a real image or a forged image. The authenticity recognition model pre-stores the real text feature and the forged text feature. The real text feature is determined according to each piece of real description information in the predetermined description information set. The forged text feature is determined according to each piece of forged description information in the description information set. Therefore, the real text feature and the forged text feature can accurately represent authenticity of an object presented in an image corresponding to one piece of description information (namely, a text) from a semantic perspective.

In addition, in this embodiment of this application, each piece of description information includes a state field, an object field, and a template field. The state field is configured for indicating whether an object presented in an image is real or forged. The object field is configured for indicating a category of the object. The template field is configured for indicating a type of a scene presented by the image. A state field of the real description information is configured for indicating that the object presented in the image is real, and a state field of the forged description information is configured for indicating that the object presented in the image is forged, so that the authenticity recognition model learns the fine-grained semantic information, to improve a generalization capability of the model, so as to improve accuracy of image authenticity detection.

In addition, for a problem that because two categories of real and forgery in an authenticity detection task cannot be clearly defined by using texts, a zero-shot classification capability of the CLIP model is relatively poor, in this embodiment of this application, a large quantity of description texts related to the authenticity detection task are designed to resolve the foregoing problem of the CLIP model. In addition, because a plurality of types of target objects exist in the pretraining data of the CLIP model, and an image has been matched with a text in a feature space, when the authenticity recognition model in this embodiment of this application is constructed based on the CLIP model, zero-shot authenticity detection can be performed without need of training, and no additional training needs to be performed for an image authenticity recognition scenario. Based on this, a requirement of an emergency online deepfake detection function is met in this embodiment of this application.

Based on the foregoing embodiments, in an exemplary embodiment, the inputting a to-be-detected image into a pre-trained authenticity recognition model, to obtain an authenticity detection result that is of the to-be-detected image and that is outputted by the authenticity recognition model includes:
S201: Input the to-be-detected image into the authenticity recognition model, to obtain an image feature of the to-be-detected image.
S202: Determine a first similarity between the image feature and the real text feature.
S203: Determine a second similarity between the image feature and the forged text feature.
S204: Determine whether the to-be-detected image is a real image or a forged image according to the first similarity and the second similarity.

In this embodiment of this application, the image feature of the to-be-detected image is obtained, a similarity between the image feature and the real text feature and a similarity between the image feature and the forged text feature are separately calculated, and the authenticity detection result is determined according to a magnitude relationship between the two similarities. Because both the real text feature and the forged text feature are predetermined by the model, an operation amount of determining the authenticity detection result by the model is significantly reduced, thereby improving detection efficiency.

In some embodiments, the determining the authenticity detection result according to a magnitude relationship between the two similarities may include:
when the first similarity is greater than the second similarity, determining that the authenticity detection result is the foregoing first result, that is, the to-be-detected image is a real image; and
when the first similarity is not greater than the second similarity, determining that the authenticity detection result is the foregoing second result, that is, the to-be-detected image is a forged image.

In this embodiment of this application, the real text feature is determined according to each piece of real description information in the description information set, and a state field of the real description information is configured for indicating that an object presented in an image is real. The real text feature can accurately summarize semantic information of each piece of real description information. The forged text feature is determined according to each piece of forged description information in the description information set, and a state field of the forged description information is configured for indicating that the object presented in the image is forged. The forged text feature can accurately summarize semantic information of each piece of forged description information. If the image feature of the to-be-detected image is more similar to the real text feature, it is considered that the image is a real image. If the image feature of the to-be-detected image is not similar to the real text feature, the to-be-detected image is a forged image.

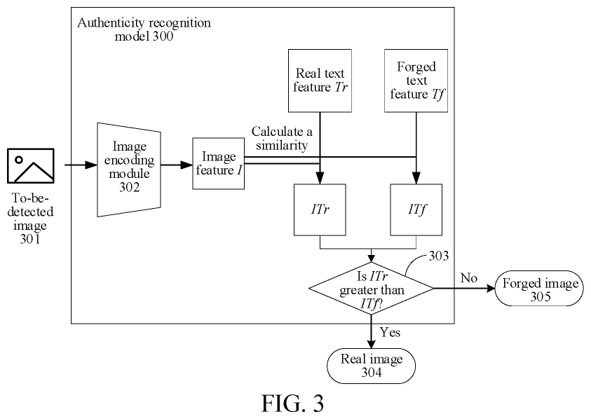

Referring to FIG. 3, FIG. 3 is an exemplary schematic diagram of a structure of an authenticity recognition model according to an embodiment of this application. The authenticity recognition model 300 includes an image encoding module 302.

As shown in FIG. 3, a to-be-detected image 301 is inputted into the image encoding module 302. The image encoding module 302 outputs an image feature I of the to-be-detected image 301, and further calculates a similarity ITr between the image feature I and a predetermined real text feature Tr, and a similarity ITf between the image feature I and a predetermined forged text feature Tf.

It is determined whether ITr is greater than ITf in 303. If ITr is greater than ITf, it is determined that the to-be-detected image 301 is a real image 304. If ITr is not greater than ITf, it is determined that the to-be-detected image 301 is a forged image 305.

In addition, when the state fields, the object fields, and the template fields are simply freely combined to generate the description information set, and when the description information set is clustered, there is a phenomenon in some description information clusters: a small amount of forged description information exists in a cluster including a large amount of real description information, and a small amount of real description information exists in a cluster including a large amount of forged description information. Therefore, this embodiment of this application further provides a solution for denoising the description information set. Specifically, a method for obtaining the description information set includes the following operations.

S301: Obtain a field set, the field set including a plurality of state fields, a plurality of object fields, and a plurality of template fields.

S302: Combine the plurality of state fields, the plurality of object fields, and the plurality of template fields, to generate a plurality of pieces of description information.

Combination manner may be random combination, traversal in specific order for combination, or the like.

S303: Classify the plurality of pieces of description information according to the template fields in all the description information, to obtain a plurality of description information clusters, each description information cluster including a plurality of pieces of description information having a same scene type.

S304: Perform the following processing on each description information cluster:
determining text features of all description information in the description information cluster;
for each piece of description information in the description information cluster,
determining at least one third similarity between a text feature of the description information and a text feature of other description information having a same state field;
determining at least one fourth similarity between the text feature of the description information and a text feature of other description information having a different state field;
determining, according to the at least one third similarity and the at least one fourth similarity, accuracy of clustering the description information into the description information cluster; and
ranking accuracy of all the description information in descending order, and reserving a preset quantity of pieces of description information that are ranked top according to a ranking result, to form the description information set.

Specifically, the determining, according to the at least one third similarity and the at least one fourth similarity, accuracy of clustering the description information into the description information cluster includes: calculating a difference between an average value of the at least one third similarity and an average value of the at least one fourth similarity; and using the difference as the accuracy.

Depending on whether the description information is the real description information or the forged description information, a manner of determining the accuracy specifically includes:
respectively determining first text features of all real description information and second text features of all forged description information in a description information cluster;
for each piece of real description information, determining a first average value of third similarities between a first text feature of the real description information and the first text features of all the real description information in the description information cluster, determining a second average value of fourth similarities between the first text feature of the real description information and the second text features of all the forged description information in the description information cluster, and using a difference between the first average value and the second average value as accuracy of the real description information; and
for each piece of forged description information, determining a third average value of third similarities between a second text feature of the forged description information and the second text features of all the forged description information in the description information cluster, determining a fourth average value of fourth similarities between the second text feature of the forged description information and the first text features of all the real description information in the description information cluster, and using a difference between the third average value and the fourth average value as accuracy of the forged description information.

If accuracy of one piece of description information is higher, it indicates that a relationship between the description information and other description information having a same state field is closer, a relationship between the description information and other description information having a different state field is more distant, and a state field of the description information is more accurate. Therefore, in this embodiment of this application, for each description information cluster, only a preset quantity of pieces of description information that are ranked top according to a ranking result are reserved.

In this embodiment of this application, the template field is used as a basis for classification because corresponding authenticity probabilities are different in different scenes. For example, a forgery trace in a very black scene is significantly different from a forgery trace in a very bright scene. Therefore, different scenes have different authenticity representations. Therefore, when the scenes are clustered, an authenticity representation determined in each scene is more accurate.

Based on the foregoing embodiments, in an exemplary embodiment, before operation S404, regularization processing may be further performed on each text feature. The regularization can avoid overfitting, reduce a degree of overfitting of the model to training data, and improve a generalization capability of the model, reduce noise interference, and improve robustness of the model.

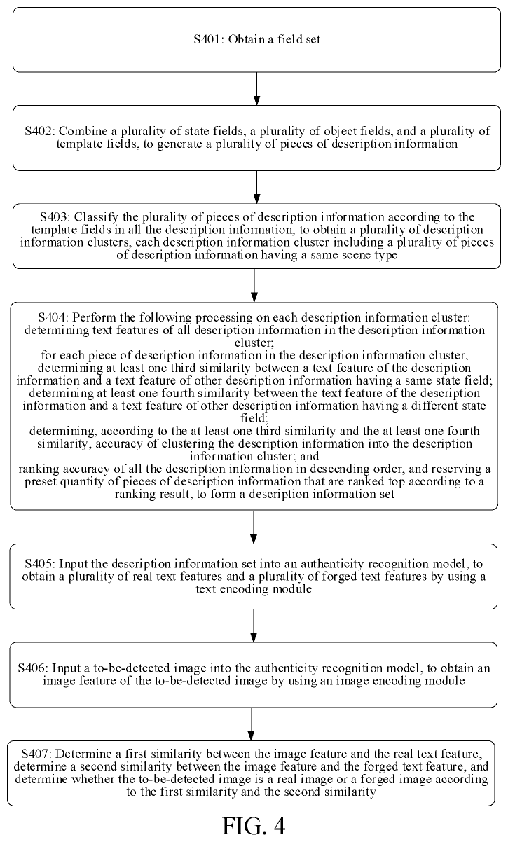

Referring to FIG. 4, FIG. 4 is a schematic flowchart of an image processing method according to an embodiment of this application. As shown in the figure, the method includes the following operations.

S401: Obtain a field set, the field set including a plurality of state fields, a plurality of object fields, and a plurality of template fields.

S402: Combine the plurality of state fields, the plurality of object fields, and the plurality of template fields, to generate a plurality of pieces of description information.

S403: Classify the plurality of pieces of description information according to the template fields in all the description information, to obtain a plurality of description information clusters, each description information cluster including a plurality of pieces of description information having a same scene type.

S404: Perform the following processing on each description information cluster:
determining text features of all description information in the description information cluster;
for each piece of description information in the description information cluster,
determining at least one third similarity between a text feature of the description information and a text feature of other description information having a same state field;
determining at least one fourth similarity between the text feature of the description information and a text feature of other description information having a different state field;
determining, according to the at least one third similarity and the at least one fourth similarity, accuracy of clustering the description information into the description information cluster; and
ranking accuracy of all the description information in descending order, and reserving a preset quantity of pieces of description information that are ranked top according to a ranking result, to form the description information set.

S405: Input the description information set into an authenticity recognition model, to obtain a plurality of real text features and a plurality of forged text features by using a text encoding module.

S406: Input a to-be-detected image into the authenticity recognition model, to obtain an image feature of the to-be-detected image by using an image encoding module.

S407: Determine a first similarity between the image feature and a real text feature, determine a second similarity between the image feature and a forged text feature, and determine whether the to-be-detected image is a real image or a forged image according to the first similarity and the second similarity.

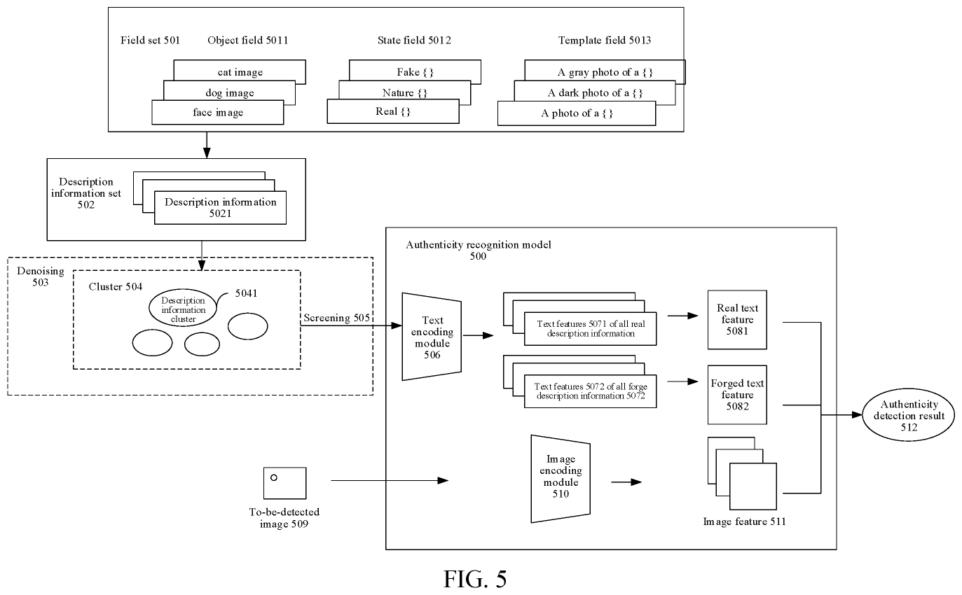

Referring to FIG. 5, FIG. 5 is a schematic flowchart of an image processing method according to another embodiment of this application. As shown in FIG. 5, a field set 501 is first obtained. The field set 501 includes a plurality of object fields 5011, a plurality of state fields 5012, and a plurality of template fields 5013. These fields are randomly combined to obtain a plurality of pieces of description information 5021, to form a description information set 502. As shown in the figure, for example, there are three object fields 5011, three state fields 5012, and three template fields 5013, and 3*3*3=27 pieces of description information 5021 may be obtained.

Then, denoising 503 processing is performed on the plurality of pieces of description information 5021, that is, as described in the foregoing operations S301 to S304. Herein, the method specifically includes the following content.

The plurality of pieces of description information are clustered according to content of the template fields 5013 in all the description information, to obtain a plurality of description information clusters 5041, each description information cluster 5041 including description information having a same scene type. For example, template fields in all description information in one description information cluster are “a dark photo of a { }”.

In addition, in this embodiment of this application, scene types indicated by template fields in some description information are empty, for example, ‘A photo of a { }.’, ‘A dark photo of a { }.’, and ‘A grey photo of a { }.’. These template fields do not involve specific scenes. Therefore, the description information whose scene types are empty belongs to a same description information cluster.

In an screening operation S505, for each description information cluster, text features of all description information in the description information cluster are determined, and for each piece of description information, an average value of at least one third similarity between a text feature of the description information and a text feature of other description information having a same state field and an average value of at least one fourth similarity between the text feature of the description information and a text feature of other description information having a different state field are determined, and a difference between the two average values is used as accuracy of the description information. Further, for each description information cluster, accuracy of all description information in the description information cluster is ranked in descending order, a preset quantity of pieces of description information that are ranked top according to a ranking result are reserved, and all the reserved description information forms a description information set.

An authenticity recognition model 500 includes a text encoding module 506 and an image encoding module 510.

All the description information obtained through screening is used as a description information set, and is inputted into the text encoding module 506, to obtain text features of all the description information.

Further, an average value of text features 5071 of all real description information is obtained, to obtain a real text feature 5081. An average value of text features 5072 of all forged description information is obtained, to obtain a forged text feature 5082.

A to-be-detected image 509 is inputted into the image encoding module 510, an image feature 510 of the to-be-detected image 509 is obtained, and a similarity between the image feature 510 and the real text feature 5081 and a similarity between the image feature 510 and a forged text feature 5082 are further determined, and an authenticity detection result 512 of the to-be-detected image is determined according to a magnitude relationship between the two similarities.

The deepfake technology has driven the emerging development of the entertainment and cultural exchange industry, but also poses a huge potential threat to facial security. On a multimedia platform, the wide spread of face-swapping videos causes a continuous decline in media credibility and is likely to mislead users.

The embodiments of this application may be applied to a forged face detection product, for example, upgrading a face verification technology, to improve security of a plurality of services such as face payment and identity authentication. The embodiments of this application facilitate evidence verification and avoid forgery of evidence using deepfakes-related technologies.

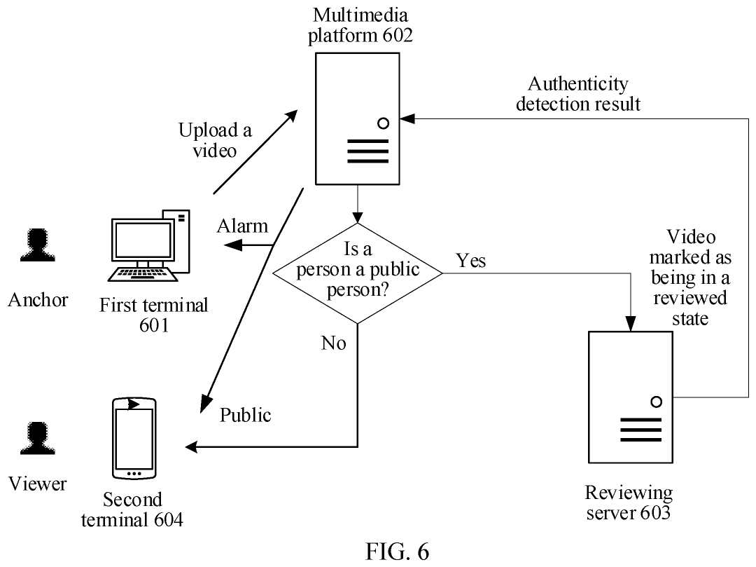

Referring to FIG. 6, FIG. 6 is an exemplary schematic diagram of applying this application to a video filtering scenario. As shown in the figure, an anchor produces a video by using a first terminal 601, and uploads the video to a multimedia platform 602.

The multimedia platform 602 recognizes a designed person in the video, and determines whether the person is a public person.

When it is determined that the person is a public person, the video is marked as being in a reviewed state, and the video marked as being in the reviewed state is not visible to a viewer of the multimedia platform such as a viewer using a second terminal 604. The multimedia platform 602 sends the video marked as being in the reviewed state to a reviewing server 603 for authenticity detection. In other words, it is recognized, by using the method described in the embodiments of this application, whether the person in the video is forged by using a deepfake technology, and an authenticity detection result, that is, whether an image in the video is a real image or a forged image, is generated.

If the reviewing server 603 determines that the image in the video is a real image, the reviewing server 603 sends a review success notification to the multimedia platform 602. The multimedia platform 602 sets the video to a public state, and the viewer may search for and browse the video by using the second terminal 604.

If the reviewing server 603 determines that the image in the video is a forged image, the reviewing server 603 sends a review failure notification to the multimedia platform 602, and the multimedia platform 602 sends an alarm to the first terminal 601.

This embodiment of this application may help the platform to screen videos, and add a prominent mark, such as “made by Deepfakes”, to a detected forged video, to ensure credibility of video content and ensure social and public trust.

This embodiment of this application may be further applied to products such as a face verification, a judicial authentication tool, and picture and video authentication.

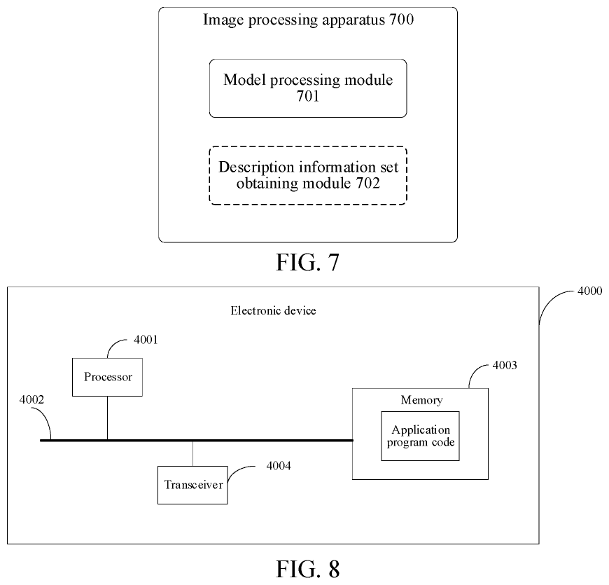

An embodiment of this application provides an image processing apparatus 700. As shown in FIG. 7, the image processing apparatus 700 includes a model processing module 701. Specifically,

The model processing module 701 is configured to:
input a to-be-detected image to an authenticity recognition model, and recognize whether the to-be-detected image is a real image or a forged image,
a description information set being predetermined, and the description information set including a plurality of pieces of real description information and a plurality of pieces of forged description information;
the plurality of pieces of real description information and the plurality of pieces of forged description information being separately inputted into the authenticity recognition model, to obtain a plurality of real text features and a plurality of forged text features; and
either of the real description information and the forged description information including a state field, an object field, and a template field,
the state field being configured for indicating whether an object presented in an image is real or forged;
the object field being configured for indicating a category of the object;
the template field being configured for indicating a type of a scene presented by the image; and
the object field being embedded in the state field, and the state field being embedded in the template field.

In some exemplary implementations, the model processing module 701 is specifically configured to:
input the to-be-detected image into the authenticity recognition model, to obtain an image feature of the to-be-detected image;
determine a first similarity between the image feature and the real text feature;
determine a second similarity between the image feature and the forged text feature;
determine whether the to-be-detected image is a real image or a forged image according to the first similarity and the second similarity.

In some exemplary implementations, the image processing apparatus further includes a description information set obtaining module 702, including:
a field set obtaining unit, configured to obtain a field set, the field set including a plurality of state fields, a plurality of object fields, and a plurality of template fields; and combine the plurality of state fields, the plurality of object fields, and the plurality of template fields, to generate a plurality of pieces of description information;
a classification unit, configured to classify the plurality of pieces of description information according to the template fields in all the description information, to obtain a plurality of description information clusters, each description information cluster including a plurality of pieces of description information having a same scene type;
an indicator calculation unit, configured to perform the following processing on each description information cluster:
determining text features of all description information in the description information cluster; and
for each piece of description information in the description information cluster,
determining at least one third similarity between a text feature of the description information and a text feature of other description information having a same state field;
determining at least one fourth similarity between the text feature of the description information and a text feature of other description information having a different state field; and
determining, according to the at least one third similarity and the at least one fourth similarity, accuracy of clustering the description information into the description information cluster; and
a ranking and screening unit, configured to: for each description information cluster, rank accuracy of all description information in descending order, and reserve a preset quantity of description information that are ranked top according to a ranking result, to form the description information set.

In some exemplary implementations, the indicator calculation unit is configured to calculate a difference between an average value of the at least one third similarity and an average value of the at least one fourth similarity; and use the difference as the accuracy.

In some exemplary implementations, the authenticity recognition model includes a text encoding module, and the real text feature and the forged text feature are determined in the following manner: obtaining a text feature of each of the plurality of pieces of real description information and a text feature of each of the plurality of pieces of forged description information by using the text encoding module; obtaining an average value of text features of all the real description information, to obtain the real text feature; and obtaining an average value of text features of all the forged description information, to obtain the forged text feature.

In some exemplary implementations, the authenticity recognition model is configured for identifying authenticity of a face image, the to-be-detected image is the face image, the real description information includes a facial feature field, and the facial feature field is configured for describing facial feature information in a face.

In some exemplary implementations, the authenticity recognition model is configured for recognizing the authenticity of the face image, the to-be-detected image is the face image, and a category indicated by the object field includes a non-face.

The apparatus in this embodiment of this application may perform the method provided in the embodiments of this application, and an implementation principle thereof is similar. Actions performed by modules in the apparatus in this embodiment of this application correspond to operations in the method in the embodiments of this application. For detailed functional descriptions of the modules of the apparatus, refer to descriptions in the corresponding method shown in the foregoing text, and details are not described herein again.

An embodiment of this application provides an electronic device, including a memory, a processor, and a computer program stored on the memory. The processor executes the computer program to implement operations of the image processing method. Compared with the related technology, the following may be implemented: inputting a to-be-detected image into an authenticity recognition model, to obtain an authenticity detection result that is of the to-be-detected image and that is outputted by the authenticity recognition model.

An exemplary embodiment provides an electronic device. As shown in FIG. 8, the electronic device 4000 shown in FIG. 8 includes a processor 4001 and a memory 4003. The processor 4001 is connected to the memory 4003, for example, through a bus 4002. In some embodiments, the electronic device 4000 may further include a transceiver 4004. The transceiver 4004 may be configured to perform data exchange between the electronic device and another electronic device, such as data sending and/or data receiving. In actual application, the transceiver 4004 is not limited to one, and the structure of the electronic device 4000 does not constitute a limitation on this embodiment of this application.

The processor 4001 may be a central processing unit (CPU), a general-purpose processor, a digital signal processor (DSP), an application specific integrated circuit (ASIC), a field programmable gate array (FPGA), or another programmable logic device, a transistor logic device, a hardware component, or any combination thereof. The processor may implement or execute various example logical blocks, modules, and circuits described with reference to content disclosed in this application. The processor 4001 may alternatively be a combination to implement a computing function, for example, may be a combination of one or more microprocessors, or a combination of a DSP and a microprocessor.

The bus 4002 may include a path for transferring information between the foregoing components. The bus 4002 may be a peripheral component interconnect (PCI) bus, an extended industry standard architecture (EISA) bus, or the like. The bus 4002 may be classified into an address bus, a data bus, a control bus, and the like. For ease of representation, only one thick line is configured for indicating the bus, but it does not indicate that there is only one bus or one type of bus.

The memory 4003 may be a read only memory (ROM) or a static storage device of another type that can store static information and instructions, a random access memory (RAM) or a dynamic storage device of another type that can store information and instructions, or an electrically erasable programmable read-only memory (EEPROM), a compact disc read only memory (CD-ROM) or other optical disk storage, optical disc storage (including a compact disc, a laser disc, an optical disc, a digital versatile disc, a Blu-ray disc, or the like), a disk storage medium or another magnetic storage device, or any other medium that can be used to carry or store a computer program and that can be accessed by a computer, but is not limited thereto.

The memory 4003 is configured to store a computer program for performing the embodiment of this application, and is controlled and performed by the processor 4001. The processor 4001 is configured to execute the computer program stored in the memory 4003, to implement the operations shown in the foregoing method embodiments.

An embodiment of this application provides a computer-readable medium, having a computer program stored therein, the computer program, when performed by a processor, implementing operations of the foregoing method embodiments and corresponding content.

An embodiment of this application provides a computer program product, including a computer program, the computer program, when performed by a processor, implementing operations of the foregoing method embodiments and corresponding content

In the specification, claims, and accompanying drawings of this application, the terms “first”, “second”, “third”, “fourth”, “1”, “2”, and the like (if existent) are intended to distinguish between similar objects but do not necessarily indicate a specific order or sequence. The data used in such a way are interchangeable in proper circumstances, so that the embodiments of the present invention described herein can be implemented in other orders than the order illustrated or described herein.

Although operations are indicated by arrows in the flowcharts of the embodiments of this application, an implementation sequence of the operations is not limited to the sequence indicated by the arrows. Unless explicitly described in this specification, in some implementation scenarios of the embodiments of this application, implementation operations in the flowcharts may be performed in another sequence according to requirements. In addition, some or all of the operations in each flowchart may include a plurality of sub-operations or a plurality of stages based on an actual implementation scenario. Some or all of these sub-operations or stages may be performed at a same moment, and each of these sub-operations or stages may be separately performed at different moments. In a scenario of different execution moments, an execution sequence of these sub-operations or stages may be flexibly configured according to requirements. This is not limited in the embodiments of this application.

In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more units or modules. Moreover, each unit or module can be part of an overall unit or module that includes the functionalities of the unit or module. The foregoing descriptions are merely exemplary implementations of some implementation scenarios of this application. Other similar implementation means used by a person of ordinary skill in the art based on the technical idea of this application without departing from the technical idea of the solutions of this application shall fall within the protection scope of the embodiments of this application.

What is claimed is:

1. An image processing method performed by an electronic device, the method comprising:
inputting a target image into an authenticity recognition model; and
recognizing whether the target image is a real image or a forged image using the authenticity recognition model, wherein the authenticity recognition model is generated by:
obtaining a description information set, and the description information set comprising a plurality of pieces of real description information and a plurality of pieces of forged description information;
separately inputting the plurality of pieces of real description information and the plurality of pieces of forged description information into the authenticity recognition model, to obtain a real text feature and a forged text feature; and
either of the real description information and the forged description information includes a state field, an object field, and a template field,
the state field being configured for indicating whether an object presented in an image is real or forged;
the object field being configured for indicating a category of the object in the image;
the template field being configured for indicating a type of a scene presented by the image; and
the object field being embedded in the state field, and the state field being embedded in the template field.

2. The method according to claim 1, wherein the recognizing whether the target image is a real image or a forged image using the authenticity recognition model comprises:
obtaining an image feature of the target image using the authenticity recognition model;
determining a first similarity between the image feature and the real text feature;
determining a second similarity between the image feature and the forged text feature; and
determining whether the target image is a real image or a forged image according to the first similarity and the second similarity.

3. The method according to claim 1, wherein the state field of the real description information is configured for indicating that the object is real, and the state field of the forged description information is configured for indicating that the object is forged.

4. The method according to claim 1, wherein the description information set is formed by:
obtaining a field set, the field set comprising a plurality of state fields, a plurality of object fields, and a plurality of template fields;
combining the plurality of state fields, the plurality of object fields, and the plurality of template fields, to generate a plurality of pieces of description information;
classifying the plurality of pieces of description information according to the template fields in all the description information, to obtain a plurality of description information clusters, each description information cluster comprising a plurality of pieces of description information having a same scene type; and
performing the following processing on each description information cluster:
determining text features of all description information in the description information cluster;
for each piece of description information in the description information cluster,
determining at least one third similarity between a text feature of the description information and a text feature of other description information having a same state field;
determining at least one fourth similarity between the text feature of the description information and a text feature of other description information having a different state field; and
determining, according to the at least one third similarity and the at least one fourth similarity, accuracy of clustering the description information into the description information cluster; and
ranking accuracy of all the description information in descending order, and reserving a preset quantity of pieces of description information that are ranked top according to a ranking result, to form the description information set.

5. The method according to claim 4, wherein the determining, according to the at least one third similarity and the at least one fourth similarity, accuracy of clustering the description information into the description information cluster comprises:
calculating a difference between an average value of the at least one third similarity and an average value of the at least one fourth similarity; and
using the difference as the accuracy.

6. The method according to claim 1, wherein the real text feature and the forged text feature are determined by:
obtaining a text feature of each of the plurality of pieces of real description information and a text feature of each of the plurality of pieces of forged description information;
obtaining an average value of text features of the real description information as the real text feature; and
obtaining an average value of text features of all the forged description information as the forged text feature.

7. The method according to claim 1, wherein the target image is the face image, the real description information comprises a facial feature field, and the facial feature field is configured for describing facial feature information in a face.

8. The method according to claim 1, wherein the target image is the face image, and a category indicated by the object field comprises a non-face.

9. An electronic device, comprising a memory, a processor, and a computer program stored on the memory, the processor executing the computer program to implement an image processing method including:
inputting a target image into an authenticity recognition model; and
recognizing whether the target image is a real image or a forged image using the authenticity recognition model, wherein the authenticity recognition model is generated by:
obtaining a description information set, and the description information set comprising a plurality of pieces of real description information and a plurality of pieces of forged description information;
separately inputting the plurality of pieces of real description information and the plurality of pieces of forged description information into the authenticity recognition model, to obtain a real text feature and a forged text feature; and
either of the real description information and the forged description information includes a state field, an object field, and a template field,
the state field being configured for indicating whether an object presented in an image is real or forged;
the object field being configured for indicating a category of the object in the image;
the template field being configured for indicating a type of a scene presented by the image; and
the object field being embedded in the state field, and the state field being embedded in the template field.

10. The electronic device according to claim 9, wherein the recognizing whether the target image is a real image or a forged image using the authenticity recognition model comprises:
obtaining an image feature of the target image using the authenticity recognition model;
determining a first similarity between the image feature and the real text feature;
determining a second similarity between the image feature and the forged text feature; and
determining whether the target image is a real image or a forged image according to the first similarity and the second similarity.

11. The electronic device according to claim 9, wherein the state field of the real description information is configured for indicating that the object is real, and the state field of the forged description information is configured for indicating that the object is forged.

12. The electronic device according to claim 9, wherein the description information set is generated by:
obtaining a field set, the field set comprising a plurality of state fields, a plurality of object fields, and a plurality of template fields;
combining the plurality of state fields, the plurality of object fields, and the plurality of template fields, to generate a plurality of pieces of description information;
classifying the plurality of pieces of description information according to the template fields in all the description information, to obtain a plurality of description information clusters, each description information cluster comprising a plurality of pieces of description information having a same scene type; and
performing the following processing on each description information cluster:
determining text features of all description information in the description information cluster;
for each piece of description information in the description information cluster,
determining at least one third similarity between a text feature of the description information and a text feature of other description information having a same state field;
determining at least one fourth similarity between the text feature of the description information and a text feature of other description information having a different state field; and
determining, according to the at least one third similarity and the at least one fourth similarity, accuracy of clustering the description information into the description information cluster; and
ranking accuracy of all the description information in descending order, and reserving a preset quantity of pieces of description information that are ranked top according to a ranking result, to form the description information set.

13. The electronic device according to claim 12, wherein the determining, according to the at least one third similarity and the at least one fourth similarity, accuracy of clustering the description information into the description information cluster comprises:
calculating a difference between an average value of the at least one third similarity and an average value of the at least one fourth similarity; and
using the difference as the accuracy.

14. The electronic device according to claim 9, wherein the real text feature and the forged text feature are determined by:
obtaining a text feature of each of the plurality of pieces of real description information and a text feature of each of the plurality of pieces of forged description information;
obtaining an average value of text features of the real description information as the real text feature; and
obtaining an average value of text features of all the forged description information as the forged text feature.

15. The electronic device according to claim 9, wherein the target image is the face image, the real description information comprises a facial feature field, and the facial feature field is configured for describing facial feature information in a face.

16. The electronic device according to claim 9, wherein the target image is the face image, and a category indicated by the object field comprises a non-face.

17. A non-transitory computer-readable storage medium, having a computer program stored therein, the computer program, when performed by a processor of an electronic device, causing the electronic device to implement an image processing method including:
inputting a target image into an authenticity recognition model; and
recognizing whether the target image is a real image or a forged image using the authenticity recognition model, wherein the authenticity recognition model is generated by:
obtaining a description information set, and the description information set comprising a plurality of pieces of real description information and a plurality of pieces of forged description information;
separately inputting the plurality of pieces of real description information and the plurality of pieces of forged description information into the authenticity recognition model, to obtain a real text feature and a forged text feature; and
either of the real description information and the forged description information includes a state field, an object field, and a template field,
the state field being configured for indicating whether an object presented in an image is real or forged;
the object field being configured for indicating a category of the object in the image;
the template field being configured for indicating a type of a scene presented by the image; and
the object field being embedded in the state field, and the state field being embedded in the template field.

18. The non-transitory computer-readable storage medium according to claim 17, wherein the recognizing whether the target image is a real image or a forged image using the authenticity recognition model comprises:
obtaining an image feature of the target image using the authenticity recognition model;
determining a first similarity between the image feature and the real text feature;
determining a second similarity between the image feature and the forged text feature; and
determining whether the target image is a real image or a forged image according to the first similarity and the second similarity.

19. The non-transitory computer-readable storage medium according to claim 17, wherein the state field of the real description information is configured for indicating that the object is real, and the state field of the forged description information is configured for indicating that the object is forged.

20. The non-transitory computer-readable storage medium according to claim 17, wherein the real text feature and the forged text feature are determined by:
obtaining a text feature of each of the plurality of pieces of real description information and a text feature of each of the plurality of pieces of forged description information;
obtaining an average value of text features of the real description information as the real text feature; and
obtaining an average value of text features of all the forged description information as the forged text feature.
